(19) United States
(12) Patent Application Publication
(10) Pub. No.: US 2008/0004729 A1
(43) Pub. Date: Jan. 3, 2008

(54) Direct encoding into a directional audio coding format

(75) Inventor: Jarmo Hiipakka, Espoo (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: NOKIA CORPORATION

(21) Appl. No.: 11/478,792

(22) Filed: Jun. 30, 2006

(51) Int. Cl. G06F 17/00; H04R 5/00

(52) U.S. Cl. 700/94; 381/17

(57) ABSTRACT

Provided are improved systems, methods, and computer program products for direct encoding of spatial sound into a directional audio coding format. The direct encoding may also include providing spatial information for a monophonic sound source. The direct encoding of spatial information may be used, for example, in interactive audio applications such as gaming environments and in teleconferencing applications such as multi-party teleconferencing.

### FIELD OF THE INVENTION

The present invention relates generally to digital processing of sound, and more particularly to systems, methods, and computer program products for digital processing of sound through direct encoding into a directional audio coding (DirAC) format for the purpose of creating a reproduction of a natural or an artificial spatial sound environment.

### BACKGROUND

Various difficulties in replicating the spatial impression of sound have been well documented and studied. And several methods have been theorized and employed as potential solutions to the problems. One problem with many of the current audio processing systems and algorithms is that the processing needs to be specifically tailored according to the final transducer layout used for reproduction. This means that processing for playback over standard stereo loudspeakers fundamentally differs from processing for headphones, and this again is different from processing for a multi-channel loudspeaker system. Only a few processing techniques allow the transducer layout to be specified as the last stage of the processing chain, i.e., to generate sound recordings which can arbitrarily be reproduced on various loudspeaker layouts while preserving the spatial impression of the sound recording.

Ambisonics is one such audio reproduction method which provides independence between spatially recorded sound and the reproduction system. In Ambisonics the desired sound field is represented by its spherical harmonic components at a single point. The reproduction phase then tries to regenerate the sound field using any suitable number of loudspeakers or a pair of headphones. Ambisonics is usually applied in its first-order realization, where the sound field is described using the zeroth-order component (omnidirectional sound pressure signal W) and three first-order components (pressure gradient signals X, Y, and Z along the three Cartesian orthogonal coordinate axes representing, respectively, a front-back feed X, a left-right feed Y, and an up-down feed Z). And while it is generally possible to formulate higher-order Ambisonics systems, they are seldom used in practice.

The first-order Ambisonics signal, which consists of the four channels W, X, Y, and Z, is referred to as a B-format signal. FIG. 1 is a pictorial representation of a B-format signal. In practice, the easiest way to obtain a B-format signal is to record the sound field using a special microphone setup that directly or through a transformation yields the desired signal. These microphone systems are manufactured, for example, by SoundField Ltd. of West Yorkshire, England.

Ambisonics is further described, for example, in Ambisonics: The Surround Alternative, Richard Elen, Surround, pp. 1-4 (2001); Whatever Happened to Ambisonics?, Richard Elen and Wendy Carlos, AudioMedia Magazine (November 1991); and Spatial Hearing Mechanisms and Sound Reproduction, D. G. Malham, The University of York, Music Technology Group (1998), the contents each of which are incorporated herein by reference in their entireties.

Spatial Impulse Response Rendering (SIRR) and Directional Audio Coding (DirAC) are additional audio reproduction methods which provide independence between spatially recorded sound and the reproduction system and are recent technologies developed at the Helsinki University of Technology in Helsinki, Finland. Both SIRR and DirAC are methods to encode and decode audio which has been recorded using a microphone array, for example using a B-format microphone. SIRR was originally developed for analyzing and reproducing impulse responses of acoustical spaces and for reproducing the analyzed responses using convolution-based reverb algorithms. SIRR analyzes the time-dependent direction of arrival and diffuseness of measured impulse responses within frequency bands to reproduce room acoustics with any multi-channel loudspeaker system. SIRR reproduces the recorded spatial (3-D room) impulse responses by processing the single-channel omnidirectional signal W from the B-format microphone signal based upon the spatial analysis data, specifically, by using different spatialization methods applied to the diffuse and non-diffuse (point-like) parts of the impulse response signal, such as using a decorrelation technique and amplitude panning. DirAC is based on the same principles as SIRR and partly on the same methods as SIRR, but is extended for reproduction of continuous sound. Thus, unlike SIRR which always relates to a single point source and reproducing impulse responses by means of convolution, DirAC is applied to continuous sound signals and permits multiple sound sources by using multiple microphones to generate a B-format signal or any microphone grid which may be used to estimate the incoming direction of the wavefront and the diffuseness of the sound field from the recorded sound.

The principle idea of the SIRR and DirAC techniques is to analyze the output from a spatial microphone system, such as a B-format SoundField microphone, by dividing the input signals into frequency bands (or channels) and estimating the direction-of-arrival and the diffuseness individually for each time instance and frequency band. The synthesis (reproduction) phase is based on taking the signal recorded by the omnidirectional microphone and distributing this signal according to the direction and diffuseness estimates gathered in the analysis phase. FIG. 2 depicts a flow diagram of the DirAC processes with B-format microphone input. FIG. 3 depicts the analysis phase on a conceptual level. And FIG. 4 depicts the synthesis (reproduction) phase on a conceptual level.

The main advantage of the SIRR/DirAC approach is the ability to generalize the recording system in a way that makes it possible to use the same representation for the sound field and use an arbitrary loudspeaker setup (or, more generally, transducer setup) in synthesis (reproduction) of the recorded sound field, i.e., DirAC is fully agnostic to the transducer system used in reproduction. This is due to the fact that the sound field is coded in parameters that are fully independent of the actual positions of the setup used for reproduction, namely direction of arrival angles (azimuth, elevation) and diffuseness. As such, the hardware for a listener to use the same processing for headphones and different loudspeaker setups.

SIRR and DirAC are further described, for example, in Spatial Impulse Response Rendering, Juha Merimaa and Ville Pulkki, Proc. 7th Int'l Conf. Digital Audio Effects (DAFx'04), Naples, Italy, pp. 139-44 (October 2004); Spatial Impulse Response Rendering: A Tool for Reproducing Room Acoustics for Multi-Channel Listening, Ville Pulkki and Juha Merimaa, Helsinki Univ. of Tech. (undated); A Method for Reproducing Natural or Modified Spatial Impression in Multichannel Listening, Tapio Lokki, Juha Merimaa, and Ville Pulkki, Int'l App. Publ. No. WO 2004/077884, Int'l Appl. No. PCT/FI2004/000093 (September 2004); Directional Audio Coding. Filterbank and STFT-Based Design, Ville Pulkki and Christof Faller, Convention Paper, 120th Audio Eng'g Soc'y Convention, Paris, France, pp. 1-12 (May 2006), the contents each of which are incorporated herein by reference in their entireties.

However, Ambisonics, SIRR, DirAC, and other spatial audio reproduction methods, methods have limitations such as limitations upon recording and/or replication of multiple sound source locations and such applications as interactive audio and teleconferencing. For example, Ambisonics relies upon recording from a single point source with a SoundField or like microphone, or (coincident) microphone array. And SIRR and DirAC are limited to analysis of recorded sound to derive spatial information, divided by time and frequency, for reproducing a single recorded (omnidirectional) sound channel.

Accordingly, there is a need in the art for improved systems, methods, and computer program products for digital processing of sound for the purpose of creating reproductions of natural and/or artificial spatial sound environments, such as used in gaming applications, teleconferencing, and audio coding.

### SUMMARY

In light of the foregoing background, embodiments of the present invention provided improved systems, methods, and computer program products for digital processing of sound for the purpose of creating a reproduction of a natural or an artificial spatial sound environment, such as, more particularly, for direct encoding of multiple spatial sound sources into a directional audio coding (DirAC) format. The present invention provides for the use of generated spatial information for a monophonic sound source and, in combination and separately, the use of multiple sound sources individually encoded into DirAC format as multiple DirAC sound source inputs. The direct encoding of spatial information into DirAC format may be used, for example, in interactive audio applications such as gaming environments and in teleconferencing applications such as multi-party teleconferencing. Also, because of the ability to combine multiple DirAC signals into a DirAC format, further embodiments of the present invention provide for artificially generating spatial information for monophonic sound signals that are used as one or more of the multiple DirAC signals.

As with SIRR and DirAC, a continuing theme of embodiments of the present invention is to provide one audio signal channel and a side information stream comprising the direction-of-arrival angles and the diffuseness components for each of the frequency bands at each time instance which may be used for synthesizing (reproducing) sound with an intended perception of the spatial presentation of the sound. Embodiments of the present invention directly encode one or more autonomous sound sources into the DirAC format, thus accommodating the use of multiple sound sources, including the use of monophonic sound signals with generated spatial information (represented by spatial attributes for the sound source). Accordingly, embodiments of the present invention may use direct encoding into DirAC format, not merely by recording sound and analyzing the recorded sound for spatial information, but, as an alternative or in addition, generating spatial information for a sound source and/or treating a sound source as monophonic sound associated with generated spatial information, thereby permitting the sound source to be any kind of sound source, including both generated sound and recorded sound. Embodiments of the present invention may directly encode one or more autonomous sound sources into the DirAC format using the generated spatial information for the one or more autonomous sound sources. Using the technique for directly encoding into the DirAC format, embodiments of the present invention are able to combine signals from multiple (monophonic, B-format, and/or DirAC) sound sources directly into the DirAC coded-domain signal representation. This technique may be applied for embodiments of the present invention for spatial (2-D and 3-D) audio reproduction and simulation environments such as in electronic gaming environments, spatial audio teleconferencing such as multi-party teleconferencing, stereo-to-multichannel up-mixing, and multichannel audio coding, among other applications.

Further, compared to the prior art including a system of generating a B-format signal using Ambisonic encoding equations and subsequently analyzing the B-format signal using the DirAC analysis process, embodiments of the present invention may be more efficient for particular situations, particularly those where the number of sound sources is small (e.g., one or two sound sources for a horizontal-only system) due to the fact that there is no need to run time-frequency analysis for all the channels in the B-format signal and that it is sufficient to implement the time-frequency analysis only for actual (recorded) sound sources. This benefit may be most particularly relevant to embodiments of the present invention implementing stereo-to-multichannel up-mixing. But embodiments of the present invention also provide the ability to permit spatial sound reproduction for applications not previously capable of being performed or fully addressed by the prior art, such as gaming environments, multi-party teleconferencing, and combined real and virtual spatial sound reproductions. As such, embodiments of the present invention provide improved systems, methods, and computer program products for digital processing of sound for the purpose of creating reproductions of natural and/or artificial spatial sound environments when the human auditory perception is taken into account for interpreting spatial cues from multiple sound sources. And while advantages of embodiments of the present invention may be relevant in cases of all applications for spatial sound reproduction, embodiments of the present invention are notably applicable in the case of multi-channel audio compression.

Embodiments of methods for directly encoding spatial sound are provided. Methods may include providing one or more sound sources, providing generated spatial information for the sound sources, dividing the sound sources into frequency bands and time segments, and correlating the generated spatial information for the sound sources to the frequency bands and time segments. Embodiments may further include combining the correlated spatial information within the divided time segments at each of the divided frequency bands and adding the sound sources.

Embodiments of methods for interactive spatial audio are also provided. Methods may include artificially generating one or more sound sources, artificially generating spatial information for the sound sources, dividing the sound sources into frequency bands and time segments, and correlating the generated spatial information for the sound sources to the frequency bands and time segments. Embodiments may further include combining the correlated spatial information within the divided time segments at each of the divided frequency bands and adding the sound sources.

Embodiments of methods for spatial audio teleconferencing are also provided. Methods may include capturing users' speech at spatial locations as sound sources, artificially generating spatial information for the sound sources, dividing the sound sources into frequency bands and time segments, and correlating the generated spatial information for the sound sources to the frequency bands and time segments. Embodiments may further include combining the correlated spatial information within the divided time segments at each of the divided frequency bands and adding the sound sources.

Corresponding and additional systems, methods, and computer program products are also provided that facilitate other digital processing of sound for spatial sound reproduction. These and other embodiments of the present invention are described further below.

### BRIEF DESCRIPTION OF THE DRAWING(S)

Having thus described the invention in general terms, reference will now be made to the accompanying drawings, which are not necessarily drawn to scale, and wherein:

FIG. 1 is a diagram of a B-format signal for representing spatial information related to sound;

FIG. 2 is a flow chart of a DirAC process for a B-format sound recording;

FIG. 3 is a schematic diagram of a DirAC analysis process for a B-format sound recording;

FIG. 4 is a schematic diagram of a DirAC synthesis process for recreating spatial cues for sound on a loudspeaker configuration;

FIG. 5 is a schematic diagram for creating a DirAC formatted spatial sound representation signal from a monophonic sound source according to one embodiment of the present invention;

FIG. 6A is a schematic diagram for creating a series of DirAC formatted signals for a corresponding series of monophonic sound sources according to one embodiment of the present invention;

FIG. 6B is a schematic diagram for creating a single DirAC formatted spatial sound representation signal from the series of DirAC formatted signals of FIG. 6A according to one embodiment of the present invention;

FIG. 7 is a schematic diagram for creating a single DirAC formatted spatial sound representation signal from a series of DirAC formatted signals according to another embodiment of the present invention;

FIG. 8A is a schematic diagram for combining multiple B-format signals, including a series of B-format signals of a corresponding series of monophonic sound sources;

FIG. 8B is a schematic diagram for creating a DirAC formatted spatial sound representation signal from the combined B-format signal of FIG. 8A according to one embodiment of the present invention;

FIG. 9 is a schematic diagram for creating a series of DirAC formatted signals for a corresponding series of B-format sound sources according to one embodiment of the present invention;

FIG. 10 is a schematic diagram of a series of DirAC formatted sound sources which may be used according to one embodiment of the present invention;

FIG. 11 is a flow chart related to obtaining and encoding multiple sound sources for use according to one embodiment of the present invention;

FIG. 12 is a flow chart related to direct encoding of the multiple sound sources of FIG. 11 into a directional audio coding format according to one embodiment of the present invention;

FIG. 13 is a schematic block diagram of an entity capable of digital encoding into a directional audio coding format in accordance with an embodiment of the present invention; and

FIG. 14 is a schematic block diagram of another entity capable of digital encoding into a directional audio coding format in accordance with an embodiment of the present invention.

### DETAILED DESCRIPTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

It will be appreciated from the following that many types of devices, including, for example, audio capture and recording devices, recording studio sound systems, sound editing devices and software, audio receivers and like audio synthesized reproduction devices, audio generating devices, video gaming systems, teleconferencing phones, teleconference server, teleconferencing software systems, speaker phones, radios, boomboxes, satellite radios, headphones, MP3 players, CD players, DVD players, televisions, personal computers, multimedia centers, laptop computers, intercom systems, and other audio products, may be used with embodiments of the present invention, as well as such as devices referenced herein as mobile stations, including, for example, mobile phones, personal data assistants (PDAs), gaming systems, and other portable handheld electronics. Further while embodiments of the present invention are described herein generally with regard to musical and vocal sounds, embodiments of the present invention apply to all types of sound.

Embodiments of the present invention may be described, for example, as extensions of the SIRR or DirAC methods, but may also be applied in similar spatial audio recording-reproduction methods which rely upon a sound signal and spatial information. Notably, however, embodiments of the present invention involve providing at least one sound source with known spatial information for the sound source which may be used for synthesis (reproduction) of the sound source in a manner that preserves or at least partially preserves a perception of the spatial information for the sound source.

As used herein, the term “monophonic input signal” is inclusive of, but not limited to: highly directional (single channel) sound recordings, such as sharply parabolic sound recordings; sound recordings with discrete or nearly-discrete spatial direction; sound recordings where actual spatial information is constrained to a discrete or nearly-discrete spatial direction; sound recordings where actual spatial information is disregarded and replaced by artificially generated spatial information; and, as for example in a virtual gaming environment, a generated sound with a virtual source position and direction. As noted in the above statement, any sound source may be interpreted (made to be) a monophonic input signal by disregarding any known spatial information for an actual (recorded) sound signal and mixing any separate channels, such as taking a W(t) channel from a B-format signal and treating it as a monophonic signal which can then be associated with generated spatial information.

### A. B-Format Synthesis for DirAC Analysis and Reproduction

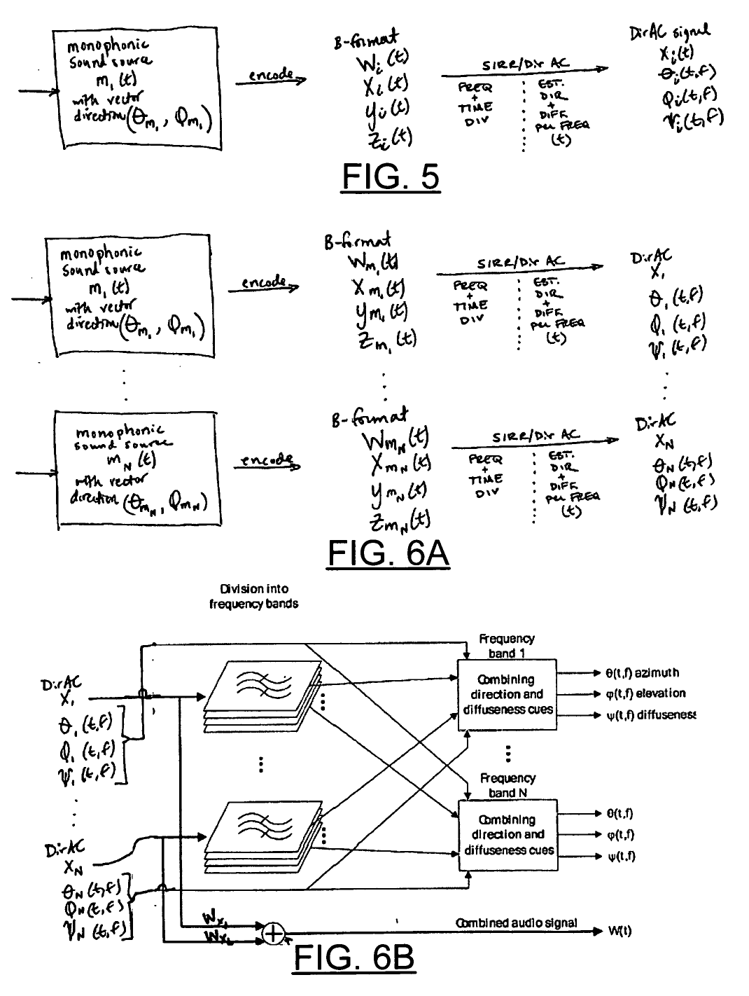

In one embodiment of the present invention, a monophonic input audio signal (source) is used to synthetically produce a B-format signal which is then analyzed and reproduced using the DirAC technology. A monophonic audio signal may be encoded into a synthesized B-format signal using the following (Ambisonics) coding equation:

$$W ( t ) = \frac{1}{\sqrt{2}} x ( t ) \\ X ( t ) = cos θ cos ϕ x ( t ) \\ Y ( t ) = sin θ cos ϕ x ( t ) \\ Z ( t ) = sin ϕ x ( t ) \qquad ( Eq . 1 )$$

where x(t) is the monophonic input audio signal, θ is the azimuth angle (anti-clockwise angle from center front), φ is the elevation angle, and W(t), X(t), Y(t), and Z(t) are the individual channels of the resulting B-format signal. The multiplier on the W signal is a convention that originates from a desire to achieve a more even level distribution between the four channels, and some references use an approximate value of 0.707 for the multiplier. In effect, the B-format signal may be used to produce a spatial audio simulation from a DirAC formatted signal, as depicted in FIG. 5. And sound sources need not be recorded with microphones for deriving spatial information, but the spatial attributes used to determine the spatial information for the sound source may be generated, such as where the vector direction (θₘ, φₘ) in FIG. 5 is generated by a computer, either artificially (arbitrarily, systematically, or with some relation to a virtual location and/or direction of the sound source, but without any association to an actual, real location and/or direction of the sound source) or with some relation to the actual spatial attributes of the sound source. And the sound source itself can be artificially generated, such as in electronic gaming environments. It is noted that generated spatial attributes may represent, in whole or in part and/or as in reality or by a relative representation, the actual spatial attributes of the sound source and/or a single source location and direction for the sound source. It may also be noted that the directional angles may be made to change over time, even though not explicitly made visible in the equation. That is, the monophonic input signal can move and/or change direction over time, similar to the sound source moving and similar to walking or turning while listening such that the sound source is perceived as coming from a different direction with respect to the listening. Because positioning a sound source in the B-format signal requires just four multiplications for each digital audio sample, encoding a monophonic sound source into a B-format signal is an efficient method to produce a spatial audio simulation. As noted above, using this encoding equation makes it possible to utilize the DirAC technology for spatial audio simulations (3-D audio), such as for gaming environments, spatial teleconferencing, stereo-to-multichannel up-mixing, multichannel audio coding, and other applications.

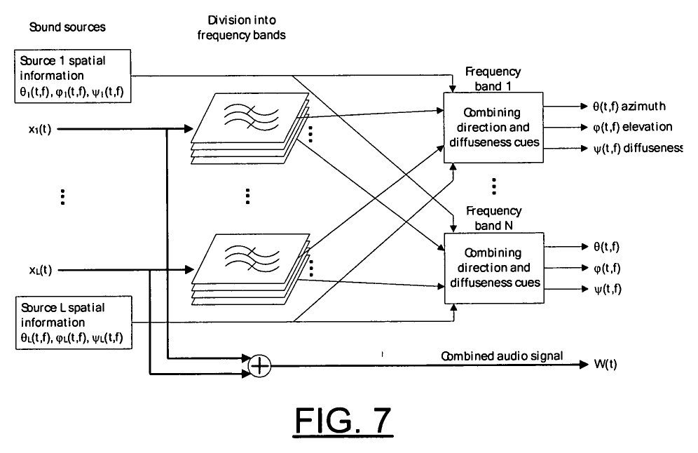

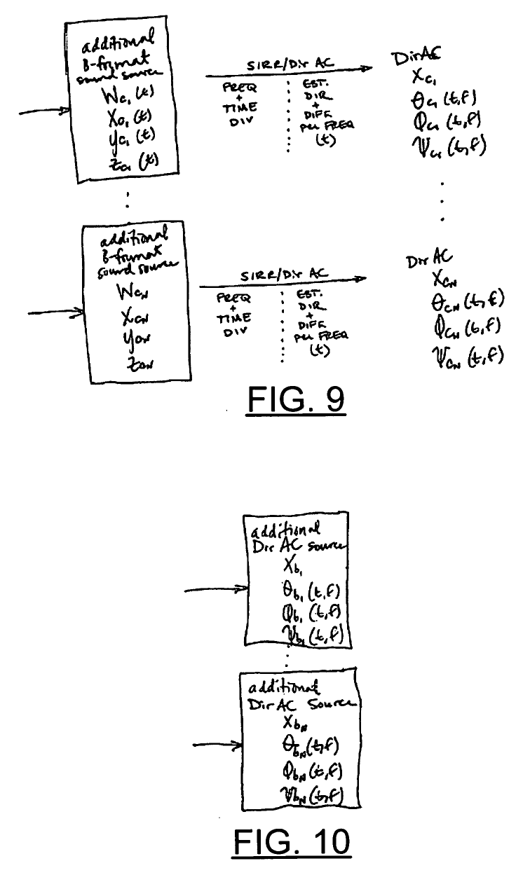

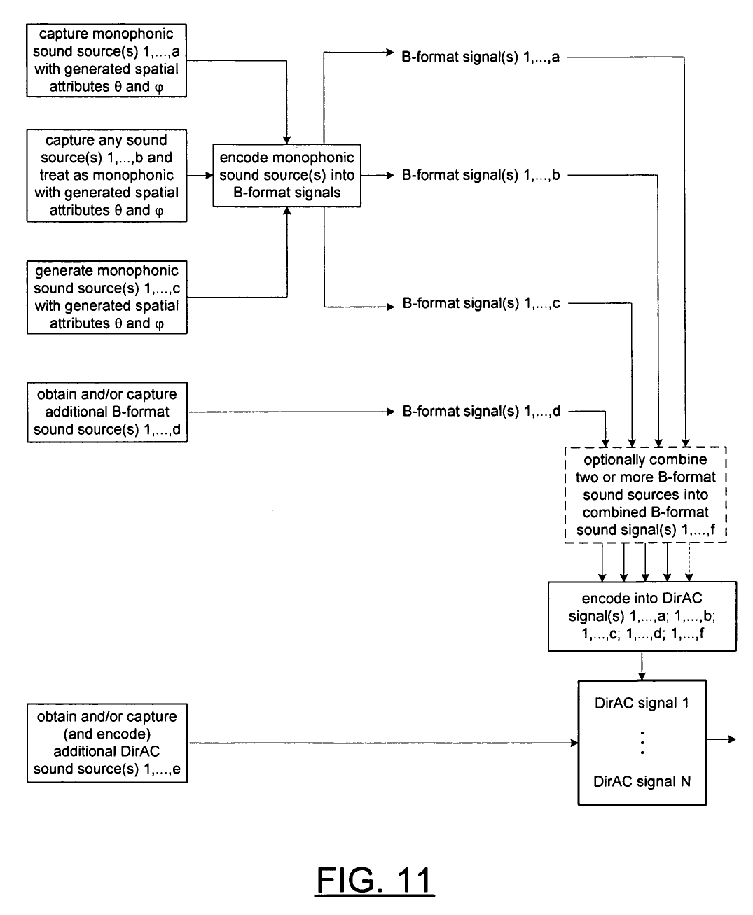

Further, multiple monophonic sources can also be encoded for embodiments of the present invention. The above equation may be individually applied for multiple monophonic sources. The resulting B-format signals may then be individually encoded into separate DirAC signals, and then the separate DirAC signals may be directly encoded, as describe further below, into a single DirAC signal. This process is depicted in FIG. 6A and FIG. 6B. FIG. 6A is a schematic diagram for creating a series of DirAC formatted signals for a corresponding series of monophonic sound sources according to one embodiment of the present invention. And FIG. 6B is a schematic diagram for creating a single DirAC formatted spatial sound representation signal from the series of DirAC formatted signals of FIG. 6A according to one embodiment of the present invention. FIG. 7 is another depiction of a schematic diagram for creating a single DirAC formatted spatial sound representation signal by directly encoding a series of DirAC formatted signals into a directional audio coding format according to another embodiment of the present invention. Additional B-format source signals may be included, encoded into DirAC spatial sound representation signals, and combined by direct encoding into a directional audio coding format, such as the series of B-format sound sources shown in FIG. 9 being encoded into a corresponding series of DirAC spatial sound representation signals according to one embodiment of the present invention. Similarly, additional DirAC spatial sound representation signals be included and combined by direct encoding into a directional audio coding format, such as the series of DirAC spatial sound representation signals shown in FIG. 10.

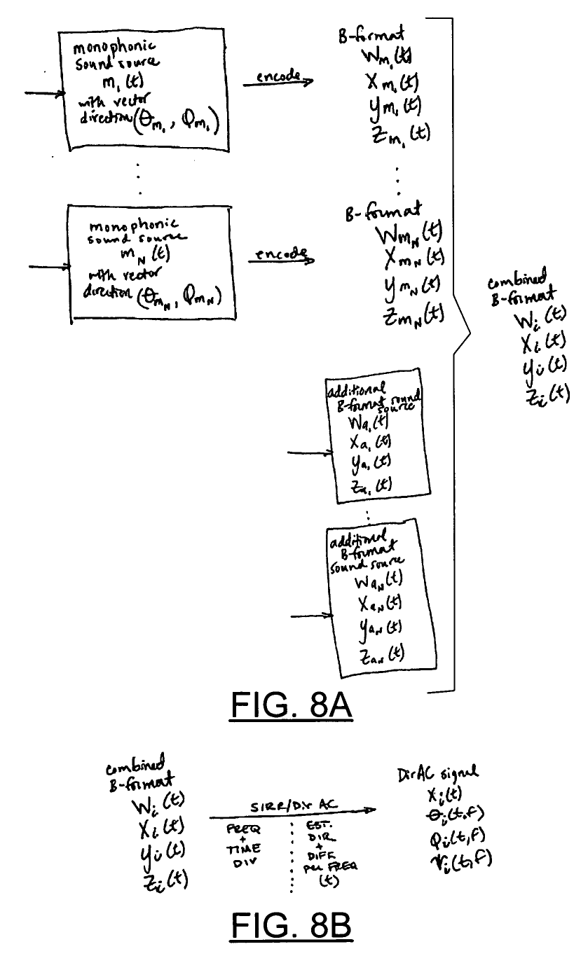

Alternatively, the multiple B-format signals resulting from encoding multiple monophonic sources may be mixed (added together, i.e., combined or summed) into a single B-format signal. Because a B-format signal is essentially a representation of the physical sound field and, as such, adheres to the basic superposition principle of linear fields, B-format signals may be mixed, for example for a four channel signal, as W=W₁+W₂+ . . . +W_{N}, X=X₁+X₂+ . . . +X_{N}, Y=Y₁+Y₂+ . . . +Y_{N}, Z=Z₁+Z₂+ . . . +Z_{N}, FIG. 8A is a schematic diagram for combining multiple B-format signals, including a series of B-format signals of a corresponding series of monophonic sound sources. And FIG. 8B is a schematic diagram for creating a DirAC formatted spatial sound representation signal from the combined B-format signal of FIG. 8A according to one embodiment of the present invention. However, as describe further herein, rather than combining multiple sound sources in B-format, or in addition to combining multiple sound sources in B-format, embodiments of the present invention may combine multiple sound sources in DirAC format and, as such, may better preserve spatial characteristics than combining multiple sound sources in B-format. B-format mixing provides the correct B-format signal for a single point in space such as at the center of a listener's head, but a listener's ears and multiple listeners are not positioned exactly at the position of this single point. But perceived spatial information may be better preserved by combining multiple sound sources in DirAC format.

FIG. 11 is a flow chart related to obtaining and encoding multiple sound sources for use according to an embodiment of the present invention. FIG. 11 summarizes the possible options for signal source inputs for embodiments of the present invention. For example, one or more a monophonic sound sources 1, . . . ,a may be captured and associated with generated spatial attributes (θ and φ). Any other sound source input may be captured and treated as a monophonic sound source by discarding any known spatial information for the signal and associating the signal with generated spatial attributes (θ and φ). As noted above, although known spatial information for a sound source may be discarded, the generated spatial attributes may optionally retain some or all of the known spatial information, such as by simplifying the known spatial information to a directional vector represented by the generated spatial attributes (θ and φ). Possibly, most predominantly, an embodiment of the present invention may also generate one or more monophonic sound sources 1, . . . ,c and associate those sound sources with generated spatial attributes (θ and φ). It is noted that all of the sound sources may be entirely arbitrary with no relation to any other sound source. This property of embodiments of the present invention accepting use of entirely independent sound sources is particularly useful for interactive audio environment, such as electronic gaming environments, and multi-party teleconferencing, in which sound source inputs also are commonly independent with no relation to any other source. Each of the monophonic sound sources 1, . . . ,a; 1, . . . ,b; and 1, . . . ,c may then be encoded into individual B-format signals. Additional B-format sound sources 1, . . . ,d may be included in an embodiment of the present invention. One or more of the B-format signals may optionally be combined into one or more combined B-format signals 1, . . . ,f or each B-format signal 1, . . . ,a; 1, . . . ,b; 1, . . . ,c; and 1, . . . ,d may remain a separate and independent signal. Any resulting B-format signals 1, . . . ,a; 1, . . . ,b; 1, . . . ,c; 1, . . . ,d; and 1, . . . ,f are then encoded into individual signals in a directional audio coding format, represented in FIG. 11 as DirAC signals 1, . . . ,N, which also include any additional DirAC sound sources 1, . . . ,e that may be included in an embodiment of the present invention. Any number of sound sources may be additional DirAC streams, as the signals from such additional DirAC streams will be mixed together with the DirAC signals encoded from B-format signals 1, . . . ,a; 1, . . . ,b; 1, . . . ,c; 1, . . . ,d; and 1, . . . ,f; and the spatial information from such additional DirAC streams will be combined seamlessly with the spatial information from the other sources 1, . . . ,a; 1, . . . ,b; 1, . . . ,c; 1, . . . ,d; and 1, . . . ,f. The resulting series of DirAC signals 1, . . . ,N, representing multiple sound source inputs may then be directly encoded into a single directional audio coding format sound representation signal, as described further below.

### B. Direct DirAC Encoding

FIG. 6B shows the principle of direct encoding in the context of an embodiment of the present invention. A series of DirAC 1, . . . ,N sound sources, such as those derived from a corresponding series of monophonic sound sources 1, . . . ,N in FIG. 6A, with their audio signal X and corresponding spatial attributes (θ₁, φᵢ, ψ₁) are used as inputs for the direct encoding. It is noted that unlike a typical representation of a DirAC signal with W(t) and θᵢ(t,f), ψᵢ(t,f), and ψᵢ(t,f) each shown for the series of frequency bands 1, . . . ,N, the series of DirAC 1, . . . ,N sound sources is represented instead by a single set of variables X, θ, φ, and ψ, but it is intended by the designation of the sound source being a DirAC that the audio signal X and spatial attributes θ, φ, and ψ are included for the series of frequency bands 1, . . . ,N, although not expressly shown. And the variable X is chosen for the audio signal, rather than W, to distinguish an audio signal X where the series of frequency bands is not shown for simplification from the typical W(t) audio signal of the DirAC format, although this is merely for convention and does not differentiate the audio signal in any way.

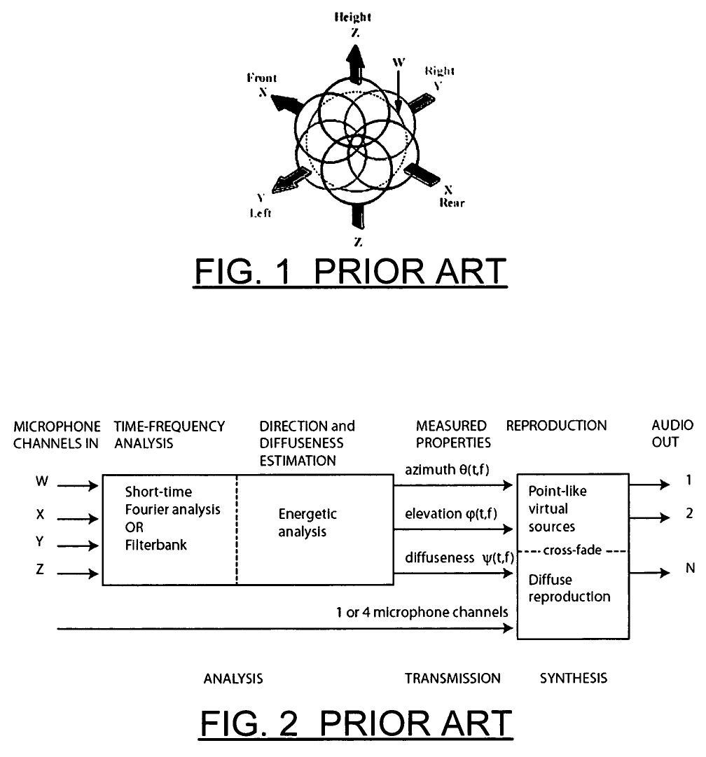

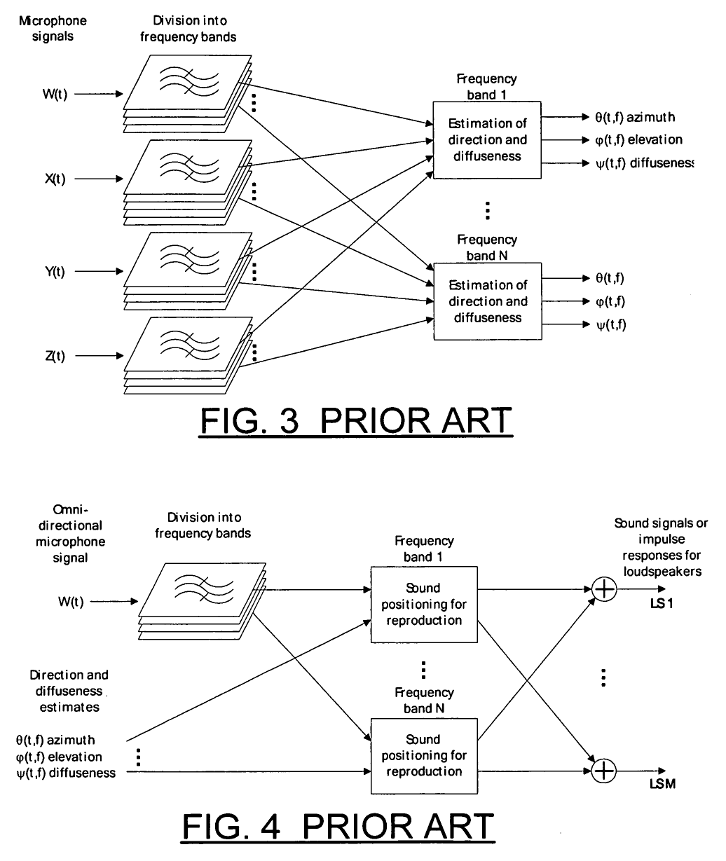

In FIG. 6B and FIG. 7, the combined spatial information for the resulting DirAC formatted spatial sound representation signal, i.e., θ(t,f), φ(t,f), and ψ(t,f) for each of frequency bands 1, . . . ,N, is a result of spectral analysis of each of the source signals X(t) and their corresponding spatial information θ(t,f), φ(t,f), and ψ(t,f) for each of frequency bands 1, . . . ,N. The signal W(t) that corresponds to the omnidirectional microphone signal described in prior art may be generated, as shown in FIG. 6B and FIG. 7, simply by mixing (adding) the source audio signals X(t) (1, . . . ,N in FIGS. 6B and 1, . . . ,L in FIG. 7) together.

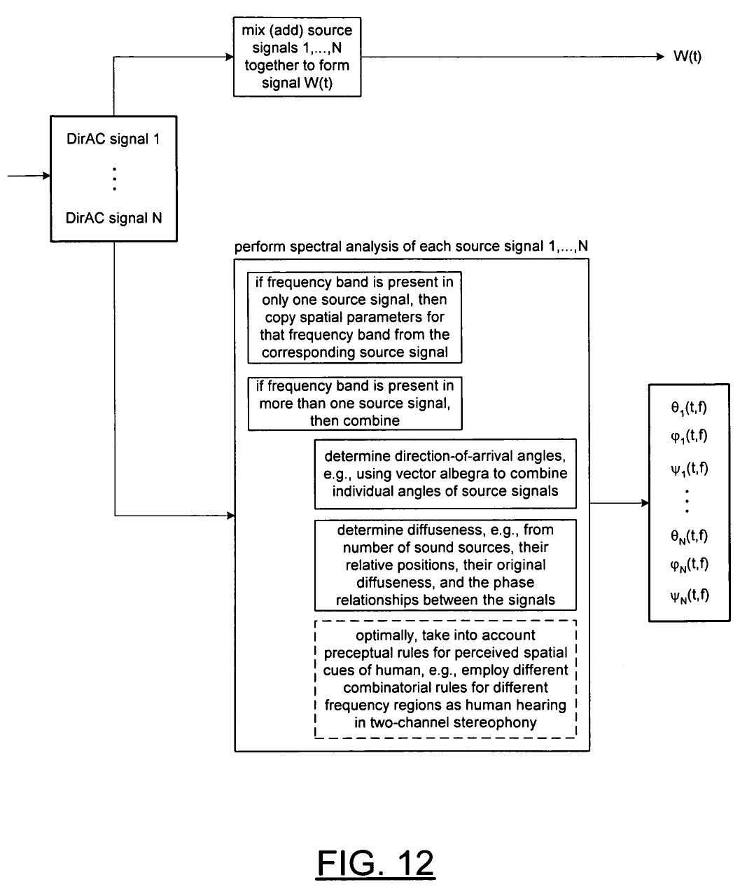

FIG. 12 shows a flow chart related to direct encoding of the multiple sound sources of FIG. 11 into a directional audio coding format according to one embodiment of the present invention. At the top, the mixing of the audio signals to form a single audio channel W(t) is shown. The bottom depicts the generation of an aggregate set of spatial parameters from the spatial attributes of the individual sound sources. It is noted that the following description is not presented in a particular order required for direct encoding the present invention, but merely that of one example embodiment of the present invention.

If a frequency band is present only in one of the input signals, in entirety or over any time segment (ideally selected to be short enough not to impact human perception, such as 10 ms), the spatial parameters for that frequency band may be simply copied from the corresponding individual source input signal for the resulting DirAC formatted signal. However, when the contents of several input signals overlap in frequency and time, the information needs to be combined using more sophisticated techniques. The combination functionality may be based on mathematical identities. For example, the direction-of-arrival angles may be determined using vector algebra to combine the individual angles. Similarly, the diffuseness may be calculated from the number of sound sources, their relative positions, their original diffuseness, and the phase relationships between the signals. Optimally, the combination function may take into account perceptual rules that determine the perceived spatial properties from the attributes of each individual DirAC streams, which makes it possible to employ different combinatorial rules for different frequency regions in much the same manner that human hearing combines sound sources into an aggregate perception, for example, in case of normal two-channel stereophony. Various computational models of spatial audio perception may be used for this diffuseness calculation.

Although the frequency analysis may be performed for all the input signals separately, note, however, that the purpose of the frequency analysis is only to provide the spatial side information; the analysis results will not later be directly converted to an audio signal, except indirectly during synthesis (reproduction) in the form of spatial cues for perception of the audio signal W(t).

### C. Applications of Direct Encoding into a Directional Audio Coding Format

Additional descriptions follow related to more specific applications for embodiments of the present invention.

1. Multichannel Encoding

Conventional multichannel audio content formats are typically horizontal-only systems, where the loudspeaker positions are explicitly defined. Such systems include, for example, all the current 5.1 and 7.1 setups. Multiple source input signals targeted for these systems may be directly encoded into the DirAC format by an embodiment of the present invention by treating the individual channels as synchronized input sound sources with the directional information generated and set according to the optimal loudspeaker positions.

2. Stereo-to-Multichannel Up-Mix

Similar to multichannel encoding, in stereo-to-multichannel up-mixing, the two stereo channels are used as multiple source inputs to the encoding system. The direction-of-arrival angles may be set by an embodiment of the present invention according to the standard stereo triangle. Modified angles are also possible for implementing specific effects. A direct encoding system of an embodiment of the present invention may then produce estimates on the perceived sound source locations and the diffuseness. And the resulting stream may subsequently be decoded for another loudspeaker system, such as a standard 5.1 setup. Such decoding may result in a relevant center channel signal and distribute the diffuse field to all loudspeakers including the surround speakers.

3. Interactive 3-D Audio

Generating interactive audio, such as for games and other interactive applications, may include simulating sound sources in three dimensions, such that sources may be freely positioned in a virtual world with respect to the listener, such as around a virtual player in a video game environment. This may be readily implemented using an embodiment of the present invention. And the techniques of the present invention may also be beneficial for implementing a room effect, which is particularly useful for video games. A room effect normally consists of separate early reflections and diffuse late reverberation. A benefit from an embodiment of the present invention is that a room effect may be created as a monophonic signal with side information describing the spatial distribution of the effect. The early reflections may be created such that they are more diffuse than the direct sound but still may have a well-defined direction-of-arrival. The late reverberation, on the other hand, may be generated with the diffuseness factor set to one, and the decoding system may facilitate actually reproducing the reverb signal as diffuse.

4. Spatial Audio Teleconferencing

Spatial audio may also be used in teleconferencing applications, for example, to make it easier to distinguish between multiple participants on a teleconference and, particularly, to make it easier to distinguish between multiple participants on a teleconference talking simultaneously. The DirAC format may be used for teleconferencing applications, as teleconferencing typically requires transmitting just one actual audio signal with the spatial information communicated as side information. As such the DirAC format is also fully mono-compatible. So for a teleconference application, the DirAC format may be employed by directly recording speech from participants on a teleconference using, for example, a SoundField microphone, when multiple persons are present in the same acoustical space.

However, for a multi-party teleconference, a resulting DirAC signal could be produced, for example, in a teleconference server system, using multiple signals from the individual conference participants as multiple sound source inputs to an embodiment of the present invention. This adaptation may easily be employed with existing conference systems because the sound signals delivered in the system could be exactly the same as currently delivered. Only the spatial information would need to be generated in addition to transmit as spatial side information.

With regard to generating spatial information for teleconferencing applications, and similarly for applications of Internet phoning and voice chatting, 3-way calling, chat rooms having audio capabilities such as computer generated sounds and voices for participants, Internet gaming environments such as virtual poker tables and virtual roulette tables, and like electronic environments, software applications, and scenarios conveying communication in any audio format which are associated with any real or virtual aspect of the system, the generation of spatial information may be used to represent sound source locations to facilitate a user distinguishing the origin of the sound. For example, if spatial information is known for a particular sound source, that spatial information may be used, in whole or in part and/or as in reality or by a relative representation, by an embodiment of the present invention in relation to representing that sound source. For example, if telephone conference participants being located in California, New York, and Texas, spatial information may be generated to identify the participants at their geographic positions on a map with respect to each other, as where the Texas listener perceives the California participant to the left (west) and the New York participant to the front-right (northeast). An additional telephone conference participant located in Florida may be associated with spatial information such that the Texas listener perceives by the Florida participant to the right (east). Other geographic, topographic, and like positional representations of reality may be similarly used. Alternatively, virtual positional representations may be implemented by embodiments of the present invention. For example, if locations are unknown or not intended to be used, a telephone conferencing system operating in accordance with the present invention may place the participants at diverging locations about a closed surface or closed perimeter, such as a ring or sphere. Further, for example, if a teleconference involves four participants, each participant may be virtually located at, and their sound source associated with generated spatial information related to, four equidistance locations about the ring. If a fifth teleconference participant is involved and, for example, designated as the lead person for the teleconference, the fifth participant may be virtually located at, and his or her sound source associated with generated spatial information related to, a point in space located above the ring (i.e., orthogonal to the plane in which the ring exists). Similarly, the sound sources for participants of a virtual roulette table could be associated with spatial information related to the positions of the participants about the circumference of the virtual roulette table.

One of ordinary skill in the art will recognize that the present invention may be incorporated into hardware and software systems and subsystems, combinations of hardware systems and subsystems and software systems and subsystems, and incorporated into network systems and wired remote locations and wireless mobile stations thereof. In each of these systems and mobile stations, as well as other systems capable of using a system or performing a method of the present invention as described above, the system and mobile station generally may include a computer system including one or more processors that are capable of operating under software control to provide the techniques described above.

Computer program instructions for software control for embodiments of the present invention may be loaded onto a computer or other programmable apparatus to produce a machine, such that the instructions which execute on the computer or other programmable apparatus create means for implementing the functions described herein. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions described herein. It will also be understood that each element, and combinations of elements, may be implemented by hardware-based computer systems, software computer program instructions, or combinations of hardware and software which perform the specified functions or steps described herein.

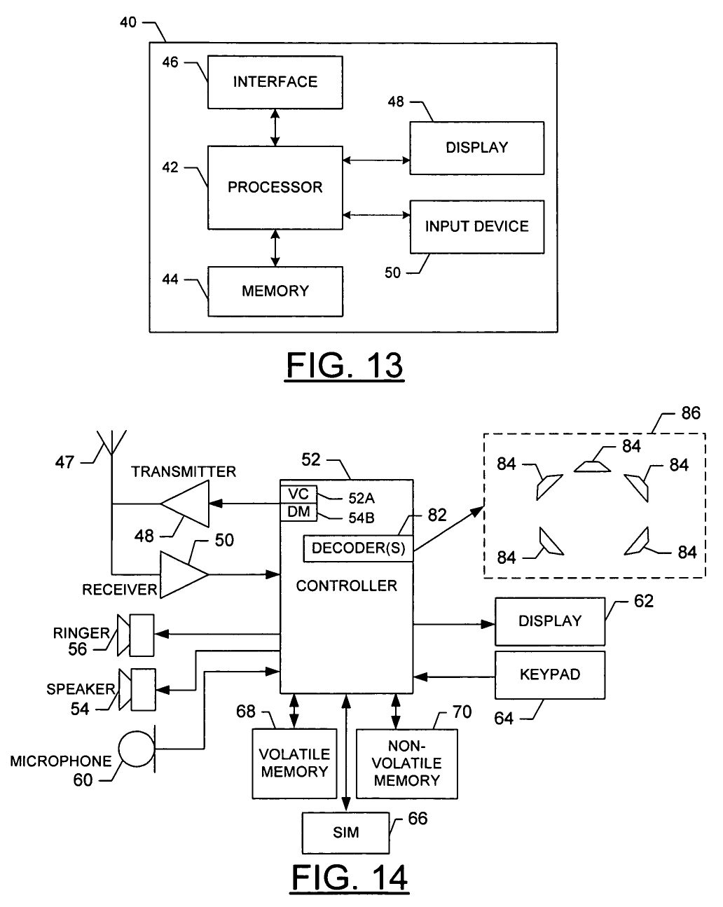

Reference is now made to FIG. 13, which illustrates a block diagram of an entity 40 capable of operating in accordance with at least one embodiment of the present invention. The entity 40 may be, for example, a teleconference server, an audio capture device, an audio recording device, a recording studio sound system, a sound editing device, an audio receiver, an audio synthesized reproduction device, an audio generating device, a video gaming system, a teleconferencing or other phone, a teleconference server, a speaker phone, a radio, a boombox, a satellite radio, headphones, an MP3 player, a CD player, a DVD player, a television, a personal computer, a multimedia center, a laptop computer, an intercom system, a mobile station, other device having audio capabilities for generating, recording, reproducing, or manipulating audio, and combinations of these devices, and like network devices operating in accordance with embodiments of the present invention. In some embodiments, one or more entities may be logically separated but co-located within one entity. For example, some network entities may be embodied as hardware, software, or combinations of hardware and software components.

As shown, the entity 40 capable of operating in accordance with an embodiment of the present invention for directly encoding into a directional audio coding format and can generally include a processor, controller, or the like 42 connected to a memory 44. The memory 44 can include volatile and/or non-volatile memory and typically stores content, data, or the like. For example, the memory 44 typically stores computer program code such as software applications or operating systems, instructions, information, data, content, or the like for the processor 42 to perform steps associated with operation of the entity in accordance with embodiments of the present invention. Also, for example, the memory 44 typically stores content transmitted from, or received by, the entity 40. Memory 44 may be, for example, random access memory (RAM), a hard drive, or other fixed data memory or storage device. The processor 42 may receive input from an input device 50 and may display information on a display 48. The processor can also be connected to at least one interface 46 or other means for transmitting and/or receiving data, content, or the like. Where the entity 40 provides wireless communication, such as in a Bluetooth network, a wireless LAN network, or other mobile network, the processor 42 may operate with a wireless communication subsystem of the interface 46. One or more processors, memory, storage devices, and other computer elements may be used in common by a computer system and subsystems, as part of the same platform, or processors may be distributed between a computer system and subsystems, as parts of multiple platforms.

FIG. 14 illustrates a functional diagram of a mobile device 52 capable of operating in accordance with an embodiment of the present invention for directly encoding into a directional audio coding format. It should be understood, that the entity illustrated and hereinafter described is merely illustrative of one type of device, such as a combination laptop (or tablet) computer with built-in cellular phone, that would benefit from the present invention and, therefore, should not be taken to limit the scope of the present invention or the type of devices which may operate in accordance with the present invention. While several embodiments of the mobile device are hereinafter described for purposes of example, other types of mobile stations, such as mobile phones, pagers, handheld data terminals and personal data assistants (PDAs), portable gaming systems, laptop computers, and other types of voice and text communications systems, can readily be employed to function with the present invention, in addition to traditionally fixed electronic devices, such as televisions, set-top boxes, appliances, personal computers, laptop computers, and like consumer electronic and computer products. The mobile device shown in FIG. 14 is a more detailed depiction of one version of an entity shown in FIG. 13.

The mobile device includes an antenna 47, a transmitter 48, a receiver 50, and a controller 52 that provides signals to and receives signals from the transmitter 48 and receiver 50, respectively. These signals include signaling information in accordance with the air interface standard of the applicable cellular system and also user speech and/or user generated data. In this regard, the mobile device may be capable of operating with one or more air interface standards, communication protocols, modulation types, and access types. More particularly, the mobile device may be capable of operating in accordance with any of a number of second-generation (2G), 2.5G and/or third-generation (3G) communication protocols or the like. Further, for example, the mobile device may be capable of operating in accordance with any of a number of different wireless networking techniques, including Bluetooth, IEEE 802.11 WLAN (or Wi-Fi®), IEEE 802.16 WiMAX, ultra wideband (UWB), and the like.

It is understood that the controller 52, such as a processor or the like, includes the circuitry required for implementing the video, audio, and logic functions of the mobile device. For example, the controller may be comprised of a digital signal processor device, a microprocessor device, and various analog to digital converters, digital to analog converters, and other support circuits. The control and signal processing functions of the mobile device are allocated between these devices according to their respective capabilities. The controller 52 thus also includes the functionality to convolutionally encode and interleave message and data prior to modulation and transmission. The controller 52 can additionally include an internal voice coder (VC) 52A, and may include an internal data modem (DM) 52B. Further, the controller 52 may include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The mobile device may also comprise a user interface such as including a conventional earphone or speaker 54, a ringer 56, a microphone 60, a display 62, all of which are coupled to the controller 52. The user input interface, which allows the mobile device to receive data, can comprise any of a number of devices allowing the mobile device to receive data, such as a keypad 64, a touch display (not shown), a microphone 60, or other input device. In embodiments including a keypad, the keypad can include the conventional numeric (0-9) and related keys (#, *), and other keys used for operating the mobile device and may include a full set of alphanumeric keys or set of keys that may be activated to provide a full set of alphanumeric keys. Although not shown, the mobile station may include a battery, such as a vibrating battery pack, for powering the various circuits that are required to operate the mobile station, as well as optionally providing mechanical vibration as a detectable output.

The mobile device can also include memory, such as a subscriber identity module (SIM) 66, a removable user identity module (R-UIM) (not shown), or the like, which typically stores information elements related to a mobile subscriber. In addition to the SIM, the mobile device can include other memory. In this regard, the mobile device can include volatile memory 68, as well as other non-volatile memory 70, which may be embedded and/or may be removable. For example, the other non-volatile memory may be embedded or removable multimedia memory cards (MMCs), Memory Sticks as manufactured by Sony Corporation, EEPROM, flash memory, hard disk, or the like. The memory can store any of a number of pieces or amount of information and data used by the mobile device to implement the functions of the mobile device. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device. The memory can also store content. The memory may, for example, store computer program code for an application and may store an update for computer program code for the mobile device.

In addition, the mobile device 52 may include one or more audio decoders 82, such as a “G-format” decoder, AC-3 decoder, DTS decoder, MPEG-2 decoder, MLP DVD-A decoder, SACD decoder, DVD-Video disc decoder, Ambisonic decoder, UHJ decoder, and like audio decoders capable of decoding a DirAC stream for such output as the 5.1 G-format, stereo format, and other multi-channel audio reproduction setups. The one or more audio decoders 82 may be capable of transmitting the resulting spatially representative sound signals to a loudspeaker system 86 having one or more loudspeakers 84 for synthesized reproduction of a natural or an artificial spatial sound environment.

Provided herein are improved systems, methods, and computer program products for direct encoding of spatial sound into a directional audio coding format. The direct encoding may also include providing spatial information for a monophonic sound source. The direct encoding of spatial information may be used, for example, in interactive audio applications such as gaming environments and in teleconferencing applications such as multi-party teleconferencing.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for directly encoding spatial sound, comprising:
providing a first sound source and a second sound source;
providing first spatial information for the first sound source and second spatial information for the second sound source;
dividing the first sound source into frequency bands and time segments;
correlating the first spatial information within the divided time segments at each of the divided frequency bands;
dividing the second sound source into the frequency bands and the time segments;
correlating the second spatial information within the divided time segments at each of the divided frequency bands;
combining the correlated first spatial information and the correlated second spatial information; and
adding the first sound source and the second sound source.

2. The method of claim 1, wherein providing the first sound source comprises generating a first monophonic sound source.

3. The method of claim 1, further comprising generating the first spatial information.

4. The method of claim 1, wherein combining the correlated first spatial information and the correlated second spatial information comprises copying the first spatial information for any of the frequency bands not present in the second sound source.

5. The method of claim 4, wherein combining the correlated first spatial information and the correlated second spatial information further comprises copying the second spatial information for any of the frequency bands not present in the first sound source.

6. The method of claim 1, wherein combining the correlated first spatial information and the correlated second spatial information comprises copying the first spatial information for any of the time sequences in which the second sound source has no amplitude.

7. The method of claim 1, wherein combining the correlated first spatial information and the correlated second spatial information comprises deriving a resulting direction of arrival angle by combining individual direction-of-arrival angles of the first sound source and the second sound source using vector algebra.

8. The method of claim 1, further comprising the first spatial information and the second spatial information to correspond with the standard stereo triangle.

9. The method of claim 1, wherein dividing the first sound source into the frequency bands and the time segments comprises decomposing the first sound source using a short-time Fourier transform.

10. The method of claim 1, wherein dividing the first sound source into the frequency bands and the time segments comprises decomposing the first sound source using a filterbank.

11. The method of claim 1, wherein dividing the first sound source into the frequency bands comprises dividing the first sound source into frequency bands according to decomposition of a human inner hear.

12. A computer program product comprising a computer-useable medium having control logic stored therein for facilitating strategic decision support, the control logic comprising:
a first code adapted to provide a first sound source and a second sound source;
a second code adapted to provide first spatial information for the first sound source and second spatial information for the second sound source;
a third code adapted to divide the first sound source into frequency bands and time segments;
a fourth code adapted to correlate the first spatial information within the divided time segments at each of the divided frequency bands;
a fifth code adapted to divide the second sound source into the frequency bands and the time segments;
a sixth code adapted to correlate the second spatial information within the divided time segments at each of the divided frequency bands;
a seventh code adapted to combine the correlated first spatial information and the correlated second spatial information; and
an eighth code adapted to add the first sound source and the second sound source.

13. The computer program product of claim 12, further comprising a ninth code for locating the first sound source at a first virtual position and artificially generating the first spatial information associated with the first virtual position.

14. The computer program product of claim 12, further comprising an eleventh code for generating the first sound source.

15. A method for interactive spatial audio, comprising:
artificially generating a first sound source;
artificially generating first spatial information for the first sound source;
dividing the first sound source into frequency bands and time segments; and
correlating the first spatial information within the divided time segments at each of the divided frequency bands.

16. The method of 15, further comprising:
providing a second sound source;
providing second spatial information for the second sound source;
dividing the second sound source into the frequency bands and the time segments;
correlating the second spatial information within the divided time segments at each of the divided frequency bands;
combining the correlated first spatial information and the correlated second spatial information; and
adding the first sound source and the second sound source.

17. The method of claim 15, wherein generating spatial information for the first sound source comprises representing a virtual position for an element in an electronic gaming environment, and wherein representing a virtual position for a first element in an electronic gaming environment comprises representing the virtual position for the first element in relation to the virtual position of a player user in the electronic gaming environment.

18. The method of claim 15, further comprising generating a third sound source and third spatial information for the third sound source representing room effect, and wherein generating the third spatial information for the room effect comprises representing the room effect to be more diffuse than one of the first sound source and the second sound source.

19. The method of claim 15, wherein generating spatial information for the first sound source comprises generating a virtual position for an element in an electronic gaming environment which changes at least one of position and direction over time.

20. The method of claim 15, wherein generating spatial information for the first sound source comprises representing a virtual position for a first participant in a networked audio communication environment, and wherein representing the virtual position for the first participant comprises virtually locating the first sound source at a point on a closed two-dimensional perimeter or a point in three dimensional space.

21. A method for spatial audio teleconferencing, comprising:
capturing at least a first user speech at a spatial location as a first sound source;
artificially generating spatial information for the first sound source, wherein the generated spatial information is not determined by analyzing a recording of the first sound source;
dividing the first sound source into frequency bands and time segments; and
correlating the generated spatial information for the first sound source within the divided time segments at each of the divided frequency bands.

22. The method of claim 21, wherein artificially generating spatial information for the first sound source comprises representing the first known reference point about a first position on a closed surface representing a universe for all potential participants in the audio teleconference.

23. The method of claim 22, wherein the first position on a closed surface is selected to be divergent from the positions on the closed surface representing any other participants in the audio teleconference.

24. The method of claim 21, wherein the spatial location of the first sound source is a first known reference point for the first user, and wherein artificially generating spatial information for the first sound source comprises representing the first known reference point.

25. The method of claim 24, wherein the first known reference point is a first geographic position for the first user, and wherein representing the first known reference point comprises representing the first geographic position.

26. The method of claim 25, further comprising reproducing the captured first user speech of the first sound source for a second user by representing the first geographic position in relation to a second geographic position of a second known reference point of a second spatial location of the second user.

27. The method of claim 21, further comprising:
capturing at least a second user speech at a spatial location as a second sound source;
artificially generating spatial information for the second sound source, wherein the generated spatial information is not determined by analyzing a recording of the second sound source;
dividing the second sound source into frequency bands and time segments;
correlating the generated spatial information for the second sound source within the divided time segments at each of the divided frequency bands;
capturing at least a third user speech at a spatial location as a third sound source;
artificially generating spatial information for the third sound source, wherein the generated spatial information is not determined by analyzing a recording of the third sound source;
dividing the third sound source into frequency bands and time segments; and
correlating the generated spatial information for the third sound source within the divided time segments at each of the divided frequency bands.

28. The method of claim 27, wherein the spatial location of the first sound source is a first known reference point for the first user, the spatial location of the second sound source is a second known reference point for the second user, and the spatial location of the third sound source is a third known reference point for the third user, and wherein artificially generating spatial information for the first, second, and third sound sources comprises representing the first, second, and third known reference points, respectively.

29. The method of claim 28, wherein the first known reference point is a first geographic position for the first user, the second known reference point is a second geographic position for the second user, and the third known reference point is a third geographic position for the third user, and wherein representing the first, second, and third known reference points comprises representing the first, second, and third geographic positions.

30. An apparatus comprising:
a processor; and
memory communicably coupled to the processor and adapted to store at least a first sound source and a second sound source and to store first spatial information for the first sound source and second spatial information for the second sound source,
wherein the processor is adapted to divide the first sound source into frequency bands and time segments, correlate the first spatial information within the divided time segments at each of the divided frequency bands; divide the second sound source into the frequency bands and the time segments; correlate the second spatial information within the divided time segments at each of the divided frequency bands; combine the correlated first spatial information and the correlated second spatial information; and add the first sound source and the second sound source, and wherein at least the first sound source is a monophonic sound source.

31. The apparatus of claim 30, wherein the processor is further adapted to artificially generate the first sound source.

32. The apparatus of claim 30, wherein the processor is further adapted to artificially generate the first spatial information.

33. The apparatus of claim 30, further comprising a decoder for outputting a sound signal representative of the combination of the first sound source, first spatial information, second sound source, and second spatial information.

34. An apparatus comprising:
a means for processing sound signals; and
a means for storing at least a first sound source and a second sound source and storing first spatial information for the first sound source and second spatial information for the second sound source,
wherein the means for processing sound signals is further adapted for dividing the first sound source into frequency bands and time segments, correlating the first spatial information within the divided time segments at each of the divided frequency bands; dividing the second sound source into the frequency bands and the time segments; correlating the second spatial information within the divided time segments at each of the divided frequency bands; combining the correlated first spatial information and the correlated second spatial information; and adding the first sound source and the second sound source, and
wherein the means for processing sound signals is further adapted for processing a monophonic sound source for the first sound source.

35. The apparatus of claim 34, wherein the means for processing sound signals is further adapted for artificially generating the first spatial information.
